(19) United States
(12) Patent Application Publication
(10) Pub. No.: US 2003/0041138 A1
(43) Pub. Date: Feb. 27, 2003

(54) Cluster membership monitor

(75) Inventors: Mark Kampe, Los Angeles, CA (US); David Penkler, Claix (FR); Stephen Mckinty, Theys (FR); Xavier-Francois Vigouroux, Brie et Angonnes (FR); Rebecca A. Ramer, San Jose, CA (US); Florence Blanc, Eybens (FR); Isabelle Colas, Courbevoie (FR)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Sun Microsystems, Inc.

(21) Appl. No.: 10/152,342

(22) Filed: May 22, 2002

Related U.S. Application Data
(63) Continuation-in-part of application No. 09/847,044, filed on May 2, 2001.
(60) Provisional application No. 60/201,210, filed on May 2, 2000.
(60) Provisional application No. 60/201,099, filed on May 2, 2000.

(51) Int. Cl. G06F 15/173

(52) U.S. Cl. 709/223

(57) ABSTRACT

The present invention describes a computer network including a network membership manager. In particular, a group of nodes on a computer network are managed by a distributed membership manager. Nodes of the computer network contain membership managers that manage the interaction between the nodes. Management of the computer network includes propagating configuration data to the nodes, providing an election process for determining the master node within a group of nodes, and monitoring the health of each node so that a change in the configuration and/or management structure can be accommodated by the nodes of the network.

### CROSS-REFERENCE TO RELATED APPLICATIONS

This application is a Continuation in Part of co-pending application Ser. No. 09/847,044, filed on May 2, 2001, which claims the benefit of U.S. Provisional Patent Application No. 60/201,210, filed May 2, 2000, and entitled “Cluster Membership Monitor,” and U.S. Provisional Patent Application No. 60/201,099, filed May 2, 2000, and entitled “Carrier Grade High Availability Platform,” which are hereby incorporated by reference.

### BACKGROUND OF THE INVENTION

1. Field of the Invention

This invention relates to membership management of a computer platform network, and more particularly, to a management system and method for managing a cluster, and maintaining and using cluster membership data.

2. Discussion of the Related Art

High availability computer systems provide basic and real-time computing services. In order to provide highly available services, members of the system must be aware, or capable of being aware, of the viability and accessibility of services and hardware components of the system in real-time.

Computer networks allow data and services to be distributed among computer systems. A clustered network provides a network with system services, applications, and hardware divided among the computers within the network. Each computer is generally considered to be a node. A cluster is a group of nodes connected in a way that allows them to work as a single continuously available system. As hardware or software needs change, such as during maintenance, and/or failures, nodes may be removed from, or added to, a cluster as is necessary. Clustering computers in this manner provides the ability to expand capabilities of a network, as well as to provide redundancy within the network. Through redundancy, the cluster can continue to provide services transparently during maintenance and/or failures.

A clustered computer system can maintain current information about the cluster to accurately provide services. Conventional system availability has typically been provided through a simple call and answer mechanism. At regular intervals a call is made to each node within the cluster and an answer is expected from each within a specified amount of time. If no answer is received, it is presumed that any non-answering node has failed, or is otherwise unavailable.

Management of the cluster with this type of call and answer mechanism is limited. Sophisticated information beyond node availability is not provided. Management of configuration data, and other types of information, through out the cluster may not be possible. Additionally, system failure, including a monitor failure, may necessitate redundancy of the entire monitoring application.

Moreover, system costs are also increased by the need for additional memory and storage space for the redundant applications used to manage the system and monitor system viability.

These and other deficiencies exist in current cluster monitoring applications. Therefore, a solution to these problems is needed, providing a cluster membership monitor specifically designed for clustered networks that is capable of monitoring system viability, as well as management of the cluster, and the monitor application.

### SUMMARY OF THE INVENTION

In one embodiment the invention comprises a computer network comprising, a plurality of nodes, a communications channel connecting the plurality of nodes allowing each node to communicate one with another, a first membership monitor associated with the first node for receiving from storing and broadcasting to the network information used in the management of the plurality of nodes, and a second membership monitor associated with the second node for receiving from storing and broadcasting to the network information used in the management of the plurality of nodes.

In another embodiment, the invention comprises a membership monitor associated with the node of a computer network comprising a data store for storing current configuration data, a manager for receiving from, storing, and broadcasting to the network information used in the management of the node, and a programming interface interconnected with the manager providing an interface to an application, and services.

In a further embodiment the invention comprises a method for electing a master node within a computer network, comprising the steps of creating a candidate's list of master capable nodes available for election, proposing a potential master node to the nodes in the candidate's list, and electing a node as the master node.

In another embodiment the invention comprises a method for managing a group of nodes on a computer network by a membership monitor comprising the steps of maintaining a data store of configuration data, and propagating the configuration data from a first membership monitor on a first node in the group of nodes to a second membership monitor on a second node in the group of nodes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a block diagram illustrating a computer network with multiple nodes in accordance with an embodiment of the invention;

FIG. 2 illustrates a computer network with two groups of nodes on the same network in accordance with an embodiment of the invention;

FIG. 3 shows a logical view of a membership monitor according to the present invention;

FIG. 4 shows a flow diagram of the basic management process in accordance with the present invention;

FIG. 5 is a flow diagram of an election algorithm in accordance with the present invention; and

FIG. 6 is a flow diagram of a membership management algorithm in accordance with the present invention.

### DETAILED DESCRIPTION OF VARIOUS EMBODIMENTS

Reference will now be made in detail to various embodiments of the present invention, examples of which are illustrated in the accompanying drawings.

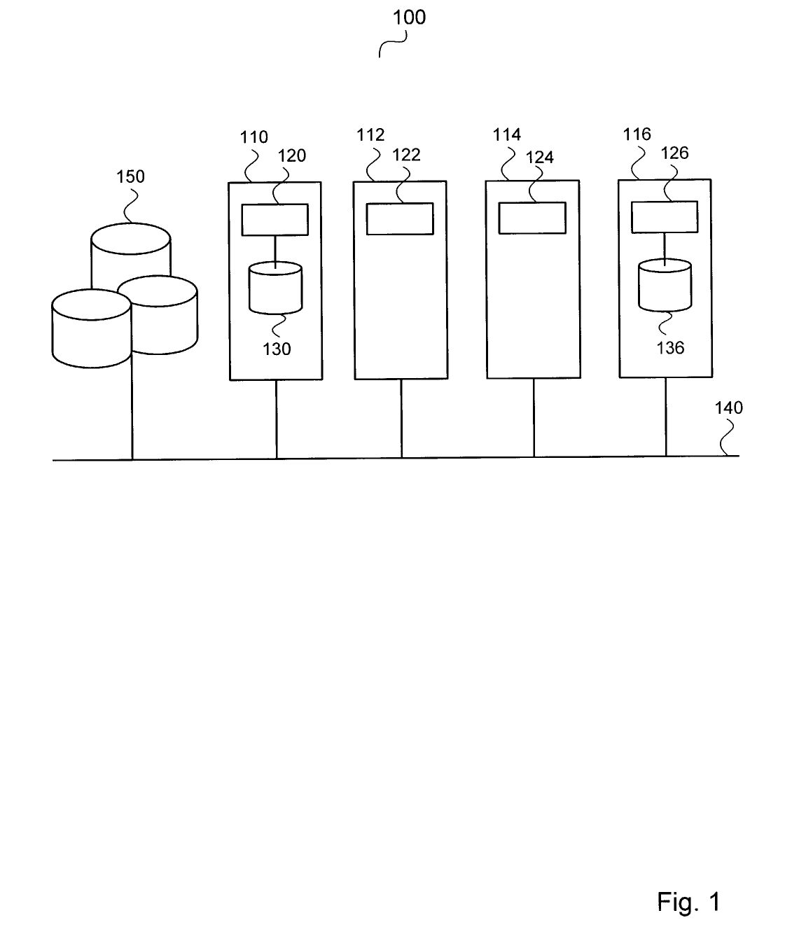

FIG. 1 illustrates a computer network 100 according to the present invention. The computer network 100 includes four nodes 110, 112, 114, and 116, a network data store 150, and a communications channel 140. The nodes and the network data store 150 are interconnected through the communications channel 140. In a further embodiment, the communications channel 140 contains redundant connections and communications paths between the nodes 110, 112, 114, and 116 and the data store 150 providing back-up communication capabilities.

In FIG. 1, each node 110, 112, 114, and 116 includes a membership monitor 120, 122, 124, and 126. The membership monitors 120, 122, 124, and 126 provide network management by communicating with each other over the communications channel 140. The membership monitors 120, 122, 124, and 126 communicate by broadcasting information to and receiving information from the network.

Information is then stored locally for use by a membership monitor 120, 122, 124, and 126. Management of the network includes such capabilities as master and vice-master election, and propagation of network information, such as membership and configuration data.

The membership monitors 120, 122, 124, and 126, communicating through the communications channel 140, provide the ability for each node 110, 112, 114, and 116 to receive and maintain a copy of network information. Network information, including membership and configuration data, allows each node on the network to maintain a current view of the computer network 100.

A node may also include a local data store 130, and 136 accessible by the membership monitor of that node. In FIG. 1, membership monitors 120 and 126 are connected with local data stores 130 and 136, respectively.

The local data store maintains start-up configuration information for the individual node. A local data store 130, and 136 containing start-up configuration information provides the node the ability to configure itself at boot time. Nodes without a local data store must retrieve start-up configuration data from a network data store.

In a further embodiment, nodes with access to start-up configuration information are eligible to take part in an election for a master node. Because an election generally takes place as a network is booting up and a node without a local data store must wait to retrieve start-up configuration data, only those nodes with a copy of their own start-up configuration data are able to provide the information necessary to participate in an election. The local data store contains the minimal start-up configuration data needed to configure the membership monitor and elect a master. Node eligibility is determined, among other things, by a node's ability to access its own start-up configuration data.

A master node is designated by election to manage the propagation of network information to the other nodes of the computer network 100. Through the propagation of network information, each node is able to notify its client applications of the availability of each node on the network 100.

During the election, a second node is designated as the vice-master node. The vice-master is a back-up to the master and provides for an immediate reassignment of the master role when necessary. The vice-master node monitors the master node and takes over the role of master in the event that the master fails or is otherwise removed from its role as master. The vice-master's role removes the need for a new election, minimizing outage time, during a change of the master node. After a vice-master has taken over the role of master, the new master will select a new vice-master to serve as its back-up.

The network data store 150 maintains the network configuration data for the entire network 100. A database containing information for each node available on the network 100 is stored in the configuration data maintained in the network data store 150. The master node is responsible for retrieving, when necessary, the network configuration data and propagating that information to the other nodes of the network 100.

In one embodiment the network data store 150 is an LDAP directory. In further embodiments the network data store 150 may be any type of storage device or mechanism, such as non-volatile random access memories, or standard databases, that are able to store the network configuration data.

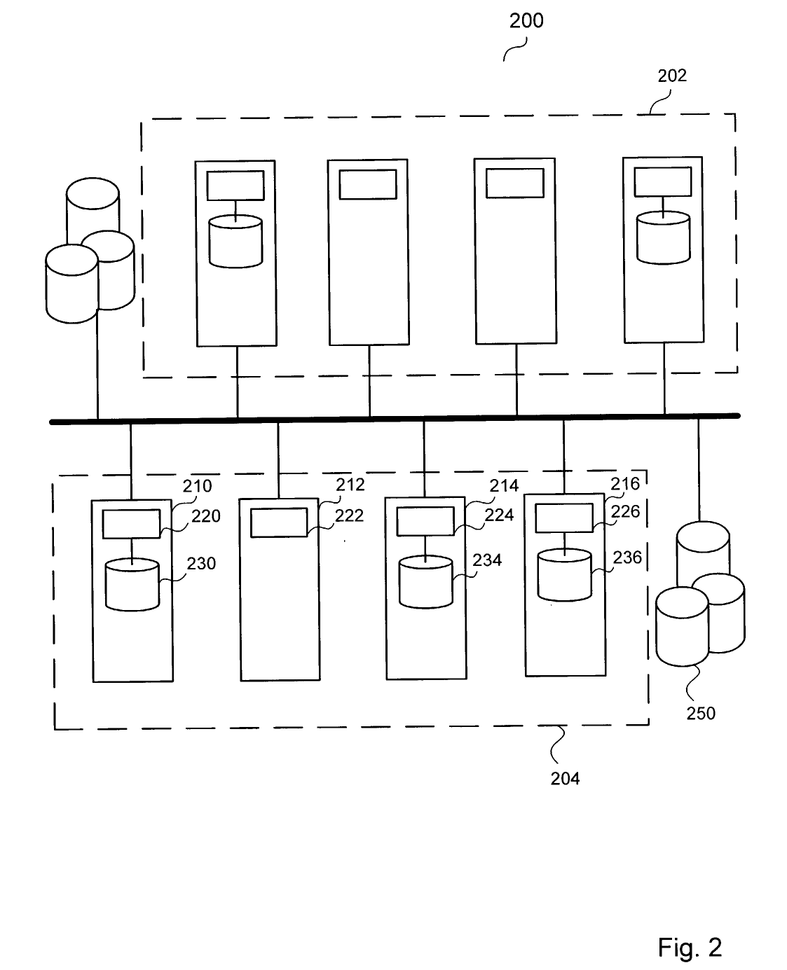

FIG. 2 illustrates a further embodiment of a computer network 200 according to the present invention, including a first group of nodes 202 and a second group of nodes 204. The first group of nodes 202 is identical to that of the computer network 100 discussed in FIG. 1. The nodes 210, 212, 214, and 216 of the second group of nodes 204 are also connected to communications channel 140. Nodes 210, 212, 214, and 216 include membership monitors 220, 222, 224, and 226. Nodes 210, 212, and 216 also include data stores 230, 234, and 236 accessible by the membership monitors 220, 224, and 226, respectively.

The second group of nodes 204 may also include a network data store 250 or share the network data store 150 used by the first group of nodes 202. Network data store 250 may be an LDAP directory, non-volatile random access memories, standard databases, or any other device capable of storing network information.

The first group of nodes 202 and the second group of nodes 204 function as separate entities on the network 200. The membership monitors 210, 212, 214, and 216 of the second group of nodes 204 are able to provide the same management features within the second group of nodes 204 as are provided by the membership monitors 110, 112, 114, and 116 of the first group of nodes 202.

To facilitate the division between the first and second groups of nodes 202 and 204, a domain id is assigned on the communications channel 140 for each group of nodes on the computer network 200. Thus, each group is uniquely identified and each node within a group has the same domain id.

Each node within a group is also assigned a unique node id within the group on the communications channel 140. Combining the domain id and node id provides a unique address for each node on the network. Thus, a membership monitor of one node is able to identify any node within the same group by using the domain id and node id. Furthermore, nodes can be assigned to, and function within, a group regardless of their physical location on the communications channel 140 of the network 200.

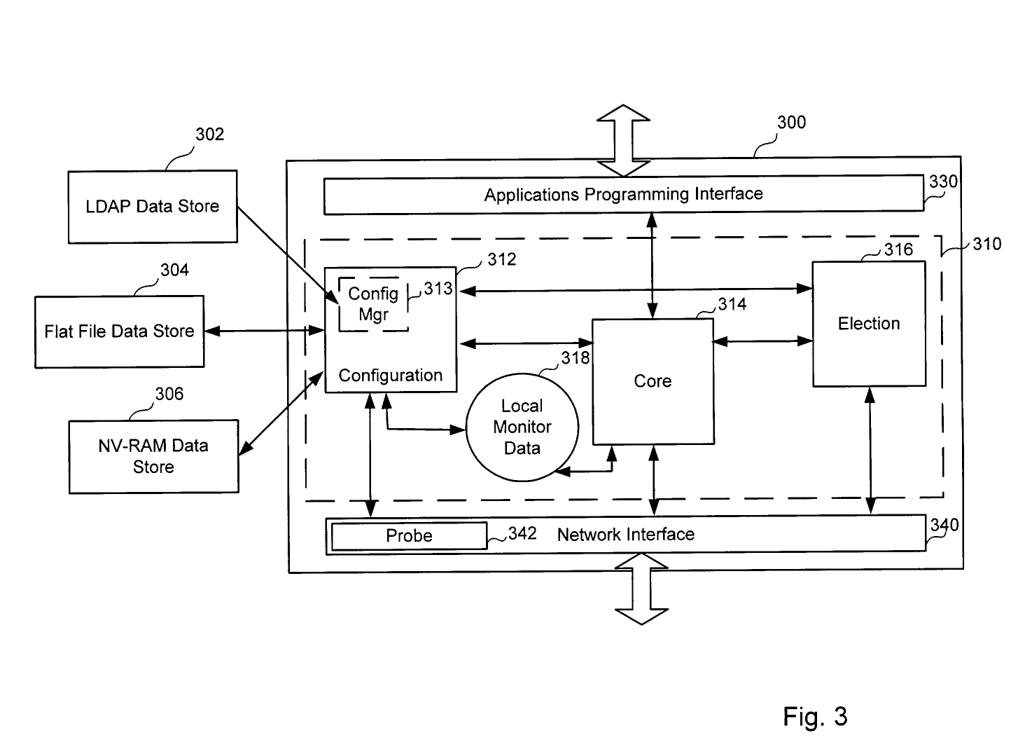

FIG. 3 shows a logical view of a membership monitor 300 interconnected with various data stores 302, 304, and 306. The membership monitor 300 includes a manager 310, an applications programming interface 330, and a network interface 340. The manager 310 is connected to the applications programming interface 330 and the network interface 340. The manager 310 communicates with, and provides network information to, applications located on a local node through the applications programming interface 330. The manager 310 communicates with the other membership monitors 300 within a group of nodes through the network interface 340.

Within a group of nodes, applications are able to distribute processing and storage capabilities among the nodes of the group. Because nodes enter or leave the group, or in some instances, fail, the application must be apprised of the current membership of the group in order to function and properly interact with the nodes without interruption or failure. Thus, the manager 310 provides information concerning the current group membership to the applications through the applications programming interface 330. With knowledge of the current group memberships, the applications are able to make use of the processing capabilities of nodes within the group, and make changes according to the changes made to the membership of the group of nodes.

The network interface 340 is used for communication between the nodes within a group. A master node receives requests from, and propagates network information to, the non-master nodes through the network interface 340. The non-master nodes request and receive information from the master through the network interface 340. The election process also takes place via communications over the network through the network interface 340.

A manager 310 of a master node provides network information through the network interface 340 to the non-master nodes of a group of nodes. A non-master obtains all network information from the master node. Requiring that all network information is provided by the membership monitor 300 of the master node provides simplicity, efficiency, and consistency in the propagation of data to the nodes of the computer network through the network interface 340.

The manager 310 of a further embodiment is divided into a configuration module 312, a core module 314, an election module 316, and a local monitor data store 318. The configuration module 312 is connected to the core module 314, the election module 316, and the local monitor data store 318. The configuration module 312, depending on the membership monitor's role (master, non-master, election eligible, etc. . . ) within the group of nodes, is responsible for the retrieval, maintenance, and propagation of configuration data maintained in one or more of the data stores 302, 304, and 306 or received from a master-node. The configuration module 312 is also responsible for maintaining a current version of configuration data in the membership monitor's own local monitor data store 318.

The configuration module may also be connected to various other data stores such as an LDAP data store 302, a flat file data store 304, or a non-volatile random access memory (NV-RAM) 306. The LDAP data store 302 contains the configuration data for the entire network or group of nodes. In one embodiment, the LDAP data store 302, and thus the configuration data, is only accessible by the membership module assigned the role of master. The LDAP data store 302 has read-only access by the membership monitor 300; therefore, the membership monitor 300 does not make changes to the data located in the LDAP data store 302. Further embodiments may use LDAP directories or any other type of database or storage mechanism for storing configuration data.

The configuration module 312 of a membership monitor elected to the role of master node, in a further embodiment, includes a configuration manager 313. The configuration manager 313 is connected to the LDAP data store 302 and monitors notifications from the LDAP data store 302. A notification from the LDAP data store 302 signal the membership monitor 300 that changes have been made to the configuration data. The master node is capable of retrieving a complete copy of configuration data or individual changes from the LDAP data store 302.

The configuration module 312 of the master node is also responsible for propagating the configuration data to the other membership monitors 300 of the group of nodes. The non-master nodes receive configuration data from the master node only. The non-master nodes store the configuration data in their own local monitor data store 318 for use locally. The configuration module 312 and local data store 318 act as a configuration data cache for the non-master nodes within the group of nodes.

In a further embodiment, an NV-RAM data store 306 is connected to the configuration module 312 of the master membership module. The NV-RAM data store 306 is used to store a back-up copy of the configuration data retrieved from the LDAP data store 302. The master membership monitor, through its configuration module 312, is responsible for maintaining the back-up data stored on the NV-RAM data store 306.

A flat file data store 304 may also be connected to the membership monitor 300 through the configuration module 312. In one embodiment, the flat file data store is located on the local data store of the node and contains only the basic start-up configuration data for the local node.

The manager's core module 314 is the central manager of the membership monitor 300. The core module 314 manages and coordinates the modules within the manager 310, maintains the role status (i.e., master, vice-master, peer) and other dynamic membership data of the membership monitors 300 on the network, manages the various network services and protocols, communicates network information to the local client applications through the applications programming interface 330, and coordinates the network information received by the membership monitor 300. The core module is connected with the configuration module 312, the local monitor data store 318, and the election module 316.

During a configuration change, the configuration module 312 notifies the core module 314 of the change. If the change affects the membership of the group of nodes, such as a node leaving or joining the group, the core module 314 notifies the local client applications of the change through the applications programming interface 330.

The core module 314 of the master is responsible for propagating membership data to the non-master nodes. The core module 314 maintains the membership data in the local monitor data store 318. Membership data provides information identifying each node's current role and its current ability to participate in the group of nodes. Membership data is sent at regular intervals (e.g., every five seconds) by the core module 314 of the master membership monitor to the core modules 314 of the non-master membership monitors. The regular propagation of the membership data provides a mechanism for notifying a node joining the group of nodes that a master is available and able to provide configuration data.

The election module 316 manages the election of a master within a group of nodes. The elected master is then assigned the responsibility of managing the nodes within the group of nodes. The election module is connected to the core module 314 and the configuration module 312. The core module 314 maintains the capabilities of the membership monitor 300 and notifies the election module 316 whether or not it is eligible to take part in the election of a master node.

During the election process, the configuration module 312 provides basic configuration data to the election module 316 for broadcasting to the other master eligible nodes taking part in the election. In an embodiment discussed earlier, the basic configuration data is stored in a flat file data store 304 located on the node's local monitor data store 318.

The network interface 340 of the membership monitor 300 is connected to the manager 310, or its various modules 312, 314, 316, to provide a communications connection to the communications channel of the computer network and ultimately to the nodes of a group. Communications directed to the network from the manager 310 or its modules 312, 314, and 316 are managed by the network interface 340.

An additional embodiment of the network interface 340 includes a probe 342. The probe 342 monitors the health of the nodes and signals the master in the event of a node failure. The vice-master node also uses the probe to monitor the master node allowing the vice-master to take over as master in the event that the master node becomes unstable or fails.

The applications programming interface 330 is also connected to the manager 310. The manager 310 notifies the local client applications of network configuration changes. For example, if a node containing functionality or data currently in use by an application of a second node were to fail, the manager 310 of the second node would notify the application of this failure allowing the application to divert processing back to itself or to a third node. Applications can also request node and network information through the applications programming interface 330. In a further embodiment, the core module 314 manages the communications with the applications programming interface 330.

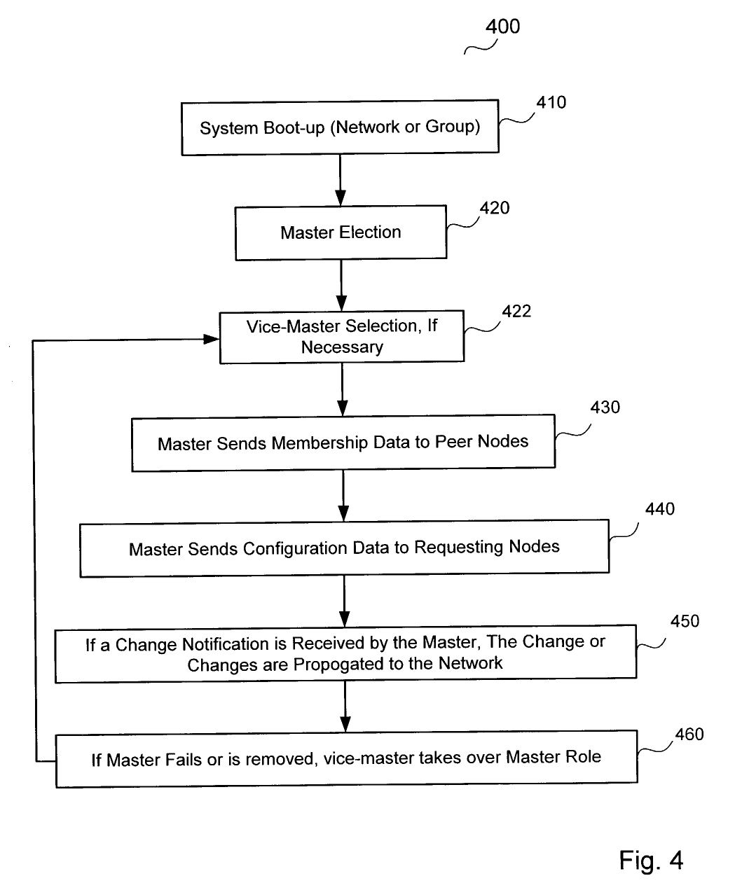

FIG. 4 shows a flow diagram depicting the basic management process 400 according to an embodiment of the present invention. The management process 400 begins at system boot for a computer network or a group of nodes, Step 410. During Step 410, the nodes of a computer network or group boot-up.

As each election eligible node starts, it initiates its election algorithm. During the master election, Step 420, a node is selected as master. Nodes that have access to local configuration data at boot-up are eligible for election to the role of master. Nodes that are not eligible for the election wait for a message from the node elected as master accepting the role of master node.

The master node is responsible for managing the nodes by providing the necessary network information to all the non-master nodes of the network or group of nodes. To ensure consistency across the network, non-master nodes request and receive network information only from the master node.

The master node typically selects a vice-master node at the end of the master election, Step 420. However, in instances in which a vice-master does not exist after a master election, Step 420, has taken place (e.g., only one eligible node available during the election, or a vice-master has failed or taken over the master role), a vice-master selection, Step 422, is made. In one embodiment a vice-master selection, Step 422, occurs only when there is no vice-master node and an eligible node enters the group. In a further embodiment, a vice-master selection, Step 422, takes place each time an eligible node joins the network or group of nodes, ensuring that the best candidate assumes the vice-master role.

After Step 420 is completed, as well as any necessary vice-master selection, Step 422, the selected master node is ready to manage the computer network or group of nodes. The membership monitor of the master node begins sending membership data messages to the other members of the network or group of nodes, Step 430. The master continues to send membership data messages at regular intervals, as well as each time there is a configuration or membership change.

In one embodiment, membership data messages include a membership revision number, a configuration revision number, and a list of nodes, including state information, currently belonging to the computer network or group of nodes. A membership monitor receiving the membership data message will compare the membership revision number and the configuration revision number to determine if membership or configuration has changed since the last membership data message was received or since the last configuration change was made. If the membership revision number is greater than the previously received number it will update its copy of membership data with the membership information in the membership data message.

When the configuration revision number is more than an incremental step greater than the previously received revision number, the membership monitor will request new configuration data. A discrepancy in the configuration number generally only occurs if the membership monitor missed a previous configuration change message; that is, it was unable to update its local revision number.

The list of nodes contained in the membership data message includes the node id and state information of each node currently in the network or group of nodes. A node's state is dynamic in nature. Examples of changes in a nodes state are 1) a vice-master role may change to master at any time the master is unable to perform that role, or 2) nodes may have joined or left the group. The various roles reflected in the state information include responsiveness and mastership designations.

The list of node states of an embodiment of the present invention include: master, vice-master, candidate, in_group, out_of_group, and excluded. The master and vice-master states simply designate the current master and vice-master nodes. The candidate state designates a node that is eligible as a master or vice-master, but does not currently function in either of those roles. The in_group state is used for a node that is active and part of the group of nodes. The out_of_group state designates a node that is not responsive and has left the group of nodes. Excluded identifies a node that is not configured to take part in the group of nodes but was seen on the network.

After an election, Step 420, and any necessary vice-master selection, Step 422, the master's sending of the membership data message, Step 430, notifies the non-master nodes that the master node is running and ready to export configuration data. Regularly sending membership data messages also allows nodes joining an already formed group to receive notification of which node is acting as master. After a node is notified which node is acting as master, it is able to request configuration data and become fully integrated into the computer network or group of nodes.

A newly added node, a node that has missed a configuration message, or a node needing configuration data for any other reason may request configuration data from the master. The master node sends configuration data in response to a request by a non-master node within the group, Step 440.

Configuration data includes the domain_id of the group of nodes, a nodes table, and subnet masks. The node table provides a list of all the nodes participating in the group with each nodes, node id, node name, and administrative attributes.

To effectively manage the local node, as well as a group of nodes, each membership monitor should have complete list of the nodes in the group of nodes, including each node's address and administrative attributes. Administrative attributes include DISQUALIFIED, FROZEN, and EXCLUDED. A DISQUALIFIED node is otherwise eligible for election as a master node, but is excluded from the election process. A FROZEN node maintains its current operational state regardless of any change notification. The FROZEN attribute is used for debugging purposes only. A node with an EXCLUDED attribute is temporarily removed from a group of nodes, such as during an upgrade of the node. If no attribute is specified, the node can fully participate in the group.

Configuration data is also propagated to the non-master nodes in certain instances without a request from the non-master node. If a change is made to the configuration data, the master node is notified. After the master is notified of a configuration change, it propagates the change information to the network or group of nodes, Step 450.

These two methods of propagation of configuration data can be described as PUSH and PULL modes. In PUSH mode, the configuration module 312 of the master node sends configuration data to the other membership monitors 300 within the group of nodes. The configuration data includes a configuration revision number and the list of configuration changes. Upon receipt of the configuration data, a node updates it's configuration revision number based on the revision number included in the configuration data and updates their local data store 318 according to the contents of the configuration data received.

In PULL mode, a membership monitor 300 of a non-master node requests the configuration data from the master node. PULL mode is typically used at boot time after a membership message has been received to retrieve the entire configuration data, and at any time when a non-master node realizes that a configuration update has been lost. A lost configuration update may be detected when the configuration revision number of a membership message does not sequentially follow the revision number currently stored by the membership monitor.

As mentioned earlier, the management of the network or group of nodes also includes the monitoring of the master node to ensure that it is performing its management functions. The vice-master is responsible for monitoring the master. The vice-master node will take over the role of master in the event that the master fails or is otherwise removed from service, Step 460. By providing a back-up master, the network or group of nodes can continue to function without the interruption of another master election or some other process to provide a new master.

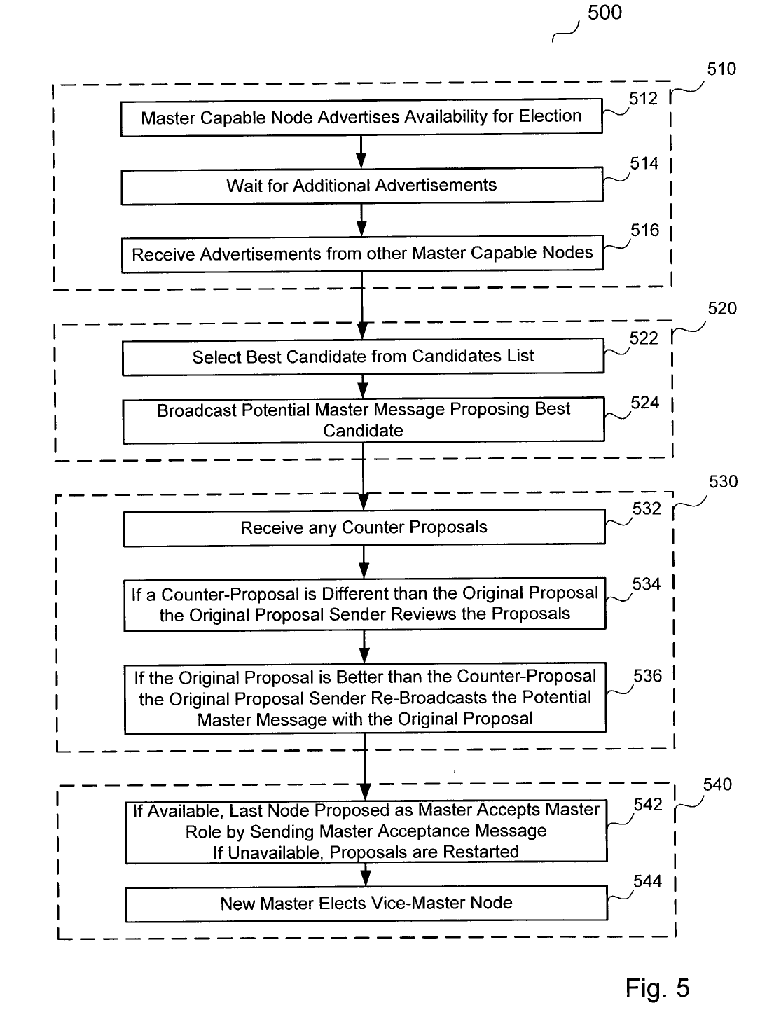

FIG. 5 shows further detail of the master election process. Four phases of the election are displayed according to an embodiment of the present invention for selecting a master and vice-master node from within a group of nodes. The phases of the election include: the construction of a candidates list, Step 510; the proposal of a potential master node, Step 520; the optional phase of a counter-proposal, Step 530; and the selection of a master and vice-master node, Step 540. Detailed sub-steps are also shown within each phase of the election process.

From the prospective of a single master-eligible membership monitor, upon start-up of a node, the membership monitor 300 advertises its availability for an election, Sub-step 512. In one embodiment, the advertisement is accomplished by the election module 316 requesting start-up configuration data from the configuration module 312. The configuration module 312 retrieves the start-up configuration data from the local data store 304 and passes it to the election module 316. After the election module 316 receives the start-up configuration data it advertises its availability to participate in the election, Sub-step 512. The advertisement provides node identification, as well as election criteria specific to the node.

After advertising its availability, the membership monitor waits for advertisements from other master-eligible nodes within the group of nodes, Sub-step 514. In a further embodiment, a timer is set to designate the wait period. Other actions or events may also terminate the timer during the election process, such as receiving a potential master message from another node. During the wait period, the membership monitor receives advertisements, if any, broadcast from other master-capable nodes and builds a list of available candidates, Sub-step 516.

After the wait period expires, or is terminated in some other fashion, the election process moves into the proposal of a potential master phase, Step 520. In one embodiment, the election module 316 reviews the advertisements that were received during the candidates list construction phase, Step 510, to select the best candidate from the candidates list, Sub-step 522.

In one embodiment, the criteria for selecting the best candidate is according to the following algorithm: 1) select the node having the highest election round (the number of times a node has been through the election process); 2) if there is more than one with an equal score, select the node having the highest previous role (master>vice-master>in group); if there is still more than one with an equal score, select the node having the lowest node id. Because node ids are unique, only one node will ultimately be selected.

After the election module has determined what it considers to be the best candidate, the election module broadcasts a potential master message proposing its best candidate, Sub-step 524. Each of the nodes involved in the election process receiving the potential master message may wait for the node to accept the role of master or review the potential master to determine if it agrees with the selection. In a further embodiment, the wait time period can be determined with the use of a timer or other actions or events.

In a further embodiment, a third phase of offering a counter-proposal, Step 530, is added to the election process 500. A counter-proposal is generally sent by a node that disagrees with the potential master message. The counter-proposal phase, Step 530, includes sending counter-proposals to, and receiving counter-proposals from, eligible nodes involved in the election process, Sub-step 532. Due to timing of the algorithm, counter-proposals may also be proposals sent by a node prior to receiving the first proposal.

In a further embodiment, a time period can be set for receiving the counter proposals. The time period can be determined with the use of a timer or other actions or events. After Sub-step 532 has completed, the election module determines whether or not the counter-proposal is different than that of its original potential master message broadcast during Sub-step 534.

If the proposal originally sent by the election module is considered a better choice by the node than the counter-proposals received during the counter-proposal period, Sub-step 532, the election module will re-send its original proposal, Sub-step 536. The election module takes no further action if a counter-proposal is better than its original proposal and will wait for a node to accept the role of master.

In the selection of a master and vice-master phase, Step 540, of the election process 500, the last node proposed as the master, if it is available, accepts the role of master node by sending an acceptance message to the other nodes participating in the election, Sub-step 542. In the event the last node proposed is unavailable, for example, due to failure, the proposed master is removed from the list of candidates and the proposal of a potential master phase, Step 520, is restarted. After accepting the role of master, the master elects a node to function as the vice-master node, Sub-step 544.

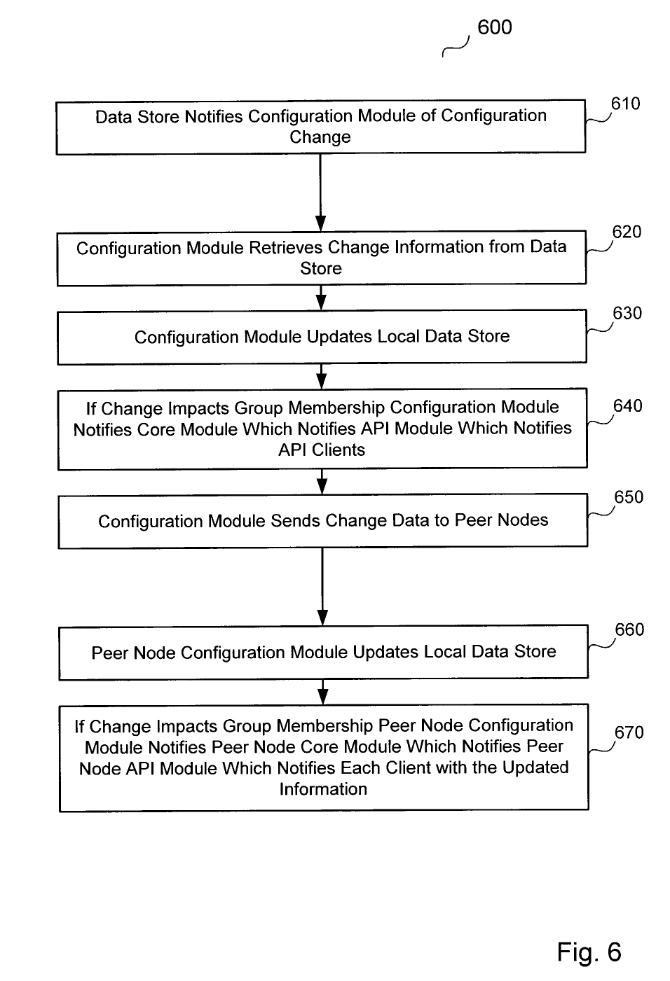

FIG. 6 is a flow diagram of a membership management algorithm for managing a change in configuration data providing sub-steps to Step 450 of FIG. 4. Membership management includes, among other things, propagation of membership data, as well as configuration data. As discussed previously, membership data includes a list of nodes and their current states of a group of nodes of the computer network. Membership data is dynamic because of the potential for constant change within a group of nodes. Membership data is propagated synchronously to the members of the group of nodes. The propagation of membership data indicates to the non-master nodes that the master is available and capable of distributing configuration data.

In one embodiment, during start-up, and after a node has been elected as the master, the master will send a membership data message to the non-master nodes. In turn, the non-master nodes request configuration data from the master.

During normal operation, a node that joins the group of nodes will receive a membership data message within a set period of time. After receiving the membership data message, the newly joined node will also request configuration data from the master.

The master asynchronously propagates configuration data to the nodes. Events triggering propagation of configuration data include requests for configuration data from the non-master nodes, as well as change notifications received from the configuration data store notifying the master of a change in the configuration data, Step 610. A notification may be sent each time a change is made, after a specified number of changes have been made, after a specified time period, or at any other specified event.

After notification, the master is responsible for retrieving the updated configuration data from the configuration data store and propagating the configuration data to the non-master nodes. The configuration module of the master membership monitor retrieves the configuration change information from the data store, Step 620. The configuration module also updates its local monitor data store, Step 630.

If the change in configuration data impacts group membership, such as a node leaving or entering the group, the configuration module will notify the core module of the change. The core module notifies the API, which in turn notifies the local API clients running on the node, Step 640. By communicating the configuration changes through the API, the clients are able to maintain an accurate list of the current group membership. Ensuring that the clients are aware of the current configuration reduces the errors and delays associated with a client requesting data or processing from a node that is no longer available or no longer configured to handle the request.

To ensure that all clients running within the group of nodes receive the updated data, the configuration module propagates the configuration data to the membership monitors of the non-master nodes, Step 650.

After receiving the configuration data from the master, the non-master nodes will update their local data store, Step 660.

As with the master, if the configuration change impacts the membership of the group of nodes, the configuration module of the non-master node will notify the core node, which forwards the change to the API and the local clients, Step 670.

It will be apparent to those skilled in the art that various modifications and variations can be made in the present invention without departing from the spirit or scope of the invention. Thus, it is intended that the present invention covers the modifications and variations of this invention provided that they come within the scope of any claims and their equivalents.

1. A computer network comprising:
a plurality of nodes;
a communications channel connecting the plurality of nodes allowing each node to communicate one with another;
a first membership monitor associated with a first node for receiving from, storing, and broadcasting to the network information used in the management of the plurality of nodes; and
a second membership monitor associated with a second node for receiving from, storing, and broadcasting to the network information used in the management of the plurality of nodes.

2. The computer network of claim 1, wherein the communications channel includes redundant connections to each node of the plurality of nodes.

3. The computer network of claim 1, wherein the communications channel includes a first domain address associated with the plurality of nodes.

4. The computer network of claim 1, wherein the communications channel includes a node address for each node.

5. The computer network of claim 1, further comprising a second plurality of nodes.

6. The computer network of claim 5, wherein the communications channel includes a second domain address for the second plurality of nodes.

7. The computer network of claim 1, wherein the first membership monitor is a master node.

8. The computer network of claim 1, wherein the second membership monitor is a vice-master node.

9. The computer network of claim 1, wherein the second membership monitor is a peer node.

10. The computer network of claim 1, further comprising an LDAP data store accessible by the first membership monitor.

11. The computer network of claim 1, further comprising a non-volatile random access memory accessible by the first membership monitor.

12. The computer network of claim 1, further comprising a flat data file accessible by the first membership monitor.

13. The computer network of claim 1, wherein the first membership monitor is interconnected with a local data store.

14. The computer network of claim 1, wherein the second membership monitor is interconnected with a local data store.

15. A membership monitor associated with a node of a computer network comprising:
a data store for storing current configuration data;
a management element for receiving from, storing, and broadcasting to the network information used in the management of the node; and
a programming interface interconnected with the management element providing an interface to an application, and services.

16. The membership monitor of claim 15, wherein the management element further comprises a core module for managing, synchronizing, and starting the membership monitor.

17. The membership monitor of claim 15, wherein the management element further comprises a configuration module for managing the initiation, modification, and propagation of configuration data.

18. The membership monitor of claim 17, wherein the configuration module is interconnected with a lightweight directory access protocol data store.

19. The membership monitor of claim 18, wherein the configuration module includes a data management component for managing interactions with the lightweight directory access protocol data store.

20. The membership monitor of claim 17, wherein the configuration module is connected to a flat file data store.

21. The membership monitor of claim 17, wherein the configuration module is connected to a non-volatile random access memory.

22. The membership monitor of claim 15, wherein the management element further comprises an election module for processing the election of a master membership monitor among a group of nodes.

23. The membership monitor of claim 15, further comprising a communications interface interconnected with the management element providing an interface to the computer network.

24. The membership monitor of claim 15, further comprising a probe for monitoring the health of the node.

25. A method for managing a group of nodes on a computer network by a membership monitor comprising the steps of:
maintaining a data store of configuration data; and
propagating the configuration data from a first membership monitor on a first node in the group of nodes to a second membership monitor on a second node in the group of nodes.

26. The method of claim 25, wherein the step of maintaining a data store of configuration data comprises the step of maintaining a data store of configuration data on a lightweight directory access protocol data store.

27. The method of claim 25, wherein the step of maintaining a data store of configuration data comprises the steps of:
maintaining a domain id;
maintaining a nodes table; and
maintaining a subnet mask.

28. The method of claim 27, wherein the step of maintaining a nodes table comprises the steps of:
maintaining a node id for each node of the group of nodes;
maintaining a node name for each node of the group of nodes; and
maintaining a list of administrative attributes for each node of the group of nodes.

29. The method of claim 25, further comprising the step of notifying the first membership monitor of a change in the configuration data.

30. The method of claim 29, wherein the step of notifying the first membership monitor of a change in the configuration data comprises the step of notifying the first membership monitor each time there is a change in the configuration data.

31. The method of claim 29, wherein the step of notifying a first membership monitor of a change in the configuration data comprises the step of notifying the first membership monitor when the number of changes in the configuration data reaches a predetermined limit.

32. The method of claim 25, wherein the step of propagating the configuration data from a first membership monitor on a node in the group of nodes to a second membership monitor on a node in the group of nodes comprises the step of sending an information package by the first membership monitor to the second membership monitor.

33. The method of claim 32, wherein the step of sending an information package by the first membership monitor to the second membership monitor comprises the step of sending a single configuration change to the second membership monitor.

34. The method of claim 32, wherein the step of sending an information package by the first membership monitor to the second membership monitor comprises the step of sending a list of changes to the second membership monitor.

35. The method of claim 32, wherein the step of sending an information package by the first membership monitor to the second membership monitor comprises the step of sending the entire contents of the data store of configuration data to the second membership monitor.

36. The method of claim 25, wherein the step of propagating the configuration data from a first membership monitor on a first node in the group of nodes to a second membership monitor on a second node in the group of nodes further comprises the step of requesting by the second membership monitor a transmission of the configuration data.

37. The method of claim 25, wherein the step of propagating the configuration data from a first membership monitor on a first node in the group of nodes to a second membership monitor on a second node in the group of nodes further comprises sending by the first membership monitor a revision number to the second membership monitor.

38. The method of claim 37, further comprising the step of updating a local copy of configuration data by the second membership monitor if the revision number is greater than a previously received revision number.

39. The method of claim 25, further comprising the step of sending membership data by the first membership monitor to the second membership monitor.

40. The method of claim 25, further comprising the step of notifying an application programming interface of the first membership monitor of a change in the configuration data.

41. The method of claim 25, further comprising the step of notifying an application programming interface of the second membership monitor of a change in the configuration data.
